(19) United States
(12) Patent Application Publication
(10) Pub. No.: US 2004/0163457 A1
(43) Pub. Date: Aug. 26, 2004

(54) Measurement of radial modulus of elasticity of paper

(76) Inventor: Marko Jorkama, Jarvenpaa (FI)

Correspondence Address: STIENNON & STIENNON, 612 W. MAIN ST., SUITE 201, P.O. BOX 1667, MADISON, WI, 53701-1667, US

(21) Appl. No.: 10/475,501

(22) PCT Filed: Apr. 24, 2002
(86) PCT No.: PCT/FI02/00336

(30) Foreign Application Priority Data
Apr. 25, 2001 (FI) 20010853

(51) Int. Cl. G01L 5/04

(52) U.S. Cl. 73/159

(57) ABSTRACT

The invention relates to a method for determining the radial modulus of elasticity of paper or a corresponding web-like material that is reeled or wound on a reel. In the method the connection between the force and deflection of a material arranged in layers is measured. The measurements necessary in the determination of the radial modulus of elasticity are conducted in a production machine for paper or a corresponding material.

The present invention relates to a method for determining the radial modulus of elasticity of paper or a corresponding web-like material that is reeled or wound on a reel. In said method the connection between the force and deflection of a material arranged in superimposed layers is measured.

A known method for measuring the radial modulus of elasticity of paper is a measurement conducted in a laboratory, which is disclosed for example in the publication by D. Roisum: The Mechanics of Winding, Tappi Press 1994, p. 62. The measurement is conducted in such a manner that a stack-of paper sheets is pressed between two planes. As a result of the measurement a curve is attained, which represents the pressing force as a function of the height of the stack. The tension is obtained by dividing the force with the measurement area. The elongation of the paper stack, which in this case is, in fact, compression, is obtained by dividing the change in the height with the original height of the stack. The paper stack is loaded until it reaches such tension which is substantially the same as the maximum tension that is assumed to be effective inside the reel. The loading of the paper stack is conducted several times in a row. The radial modulus of elasticity is the angular coefficient of the tangent of the stress-elongation curve.

It is a problem of the laboratory measurement that it is conducted with a delay; in other words reactions to problems in the production occur slowly. The shape of the paper stack does not entirely correspond to the shape of the reel in the production machine. Furthermore, it is necessary to use a paper stack, wherein it is somewhat difficult to prepare a sample for the measurement. In this measurement it is, however, necessary to use a paper stack, because it is very difficult to measure single sheets and it may cause inaccurate results.

By means of the method according to the invention it is possible to eliminate or reduce the above-mentioned problems. The method according to the invention is characterized in that the measurements of force and deflection that are necessary in the determination of the radial modulus of elasticity are conducted in a production machine of paper or a corresponding material. The term production machine refers for example to a slitter winder or a calender, in which a material in the form of a continuous web is unwound or reeled up.

The advantages of the method according to the invention are that the measurement of force and deflection can be conducted in a reel, wherein the shape of the surface to be measured is the correct one. By means of the measurement information is obtained which indicates how the reeling should be conducted, for example which web tension should be used at a given time, in other words, the measurement results can be applied in theoretical winding models. Because the measurement takes places in a production machine, it is possible to rapidly react to errors in the reeling. Inaccurately reeled material can be reeled again or rejected. The method according to the invention can be applied in several kinds of reel-ups, such as centre reel-ups or king roll reel-ups. The method can also be applied in machine reel-ups.

When the aim is to use theoretical winding models to attain winding parameter recipes, it is necessary to know the constitutive behaviour of the paper reel, i.e. the connection between the tension and elongation of the paper reel. When an elastic orthotropic plane model is used, four variables are necessary for describing this connection, of which variables the radial modulus of elasticity is dependent on the pressure inside the roll and the other three variables are typically assumed to be constant. A method has now been developed for estimation of the radial modulus of elasticity, which method will be described hereinbelow.

When the method according to the invention is used, the measurements of force and deflection necessary in the calculation of the radial modulus of elasticity are conducted in a production machine of paper or a corresponding material. In the measurement a paper reel or the like is loaded with forces of different magnitude in the direction of the radius of the paper reel, and deflections corresponding to the forces are registered. In this application, the term deflection refers to the compression of paper or a corresponding material located in layers on a reel in the direction of the radius of the reel when the reel is loaded with a radial force.

The measurement is conducted when paper reels or the like are positioned in a reel-up for example when the paper reels have been finished and the reel-up is stopped. The reels are loaded with a known force and at the same time the deflection of the reels is measured. The member loading the reels can be for example a rider roll or chucks of a winding head attached to both ends of the core and supporting the paper roll. The measurement of the deflection can be conducted for example by measuring the position of the chucks of the winding heads used for supporting the paper reels, or the position of the rider rolls. On the basis of the measurement result a curve is obtained from the deflection in the direction of the radius of the reel as a function of the force loading the reel.

The tangential modulus of elasticity of paper to be reeled or corresponding web-like material, obtained as a measurement result either in laboratory measurement or in the production machine, is placed in the theoretical loading model of the paper reel. Elastic parameters used-as initial guesses are also necessary in the theoretical loading model. On the basis of the theoretical loading model another curve is obtained from the deflection in the direction of the radius of the reel as a function of the force loading the reel.

The theoretical loading model of the paper reel can be for example a model utilizing FEM (finite element model) calculation. FEM calculation is known as such and therefore it will not be described in more detail. Generally, it can be said that the FEM calculation is utilized when the use of exact mathematical formulas is difficult for example due to their complex nature.

The curve obtained on the basis of the measurement results and the curve obtained on the basis of the theoretical loading model are compared to each other. If they match, the initial guess of the elastic parameters is correct. If the curves do not match, new values are given for the elastic parameters, and this process continues until the curve obtained by means of the theoretical loading model corresponds to the measurement results. On the basis of the obtained result it is possible to estimate the radial modulus of elasticity. In the estimation it is possible to use for example the least squares method in which a minimum is searched for the square of the difference of the calculated and measured values.

In the following, the invention will be described by means of drawings, in which,

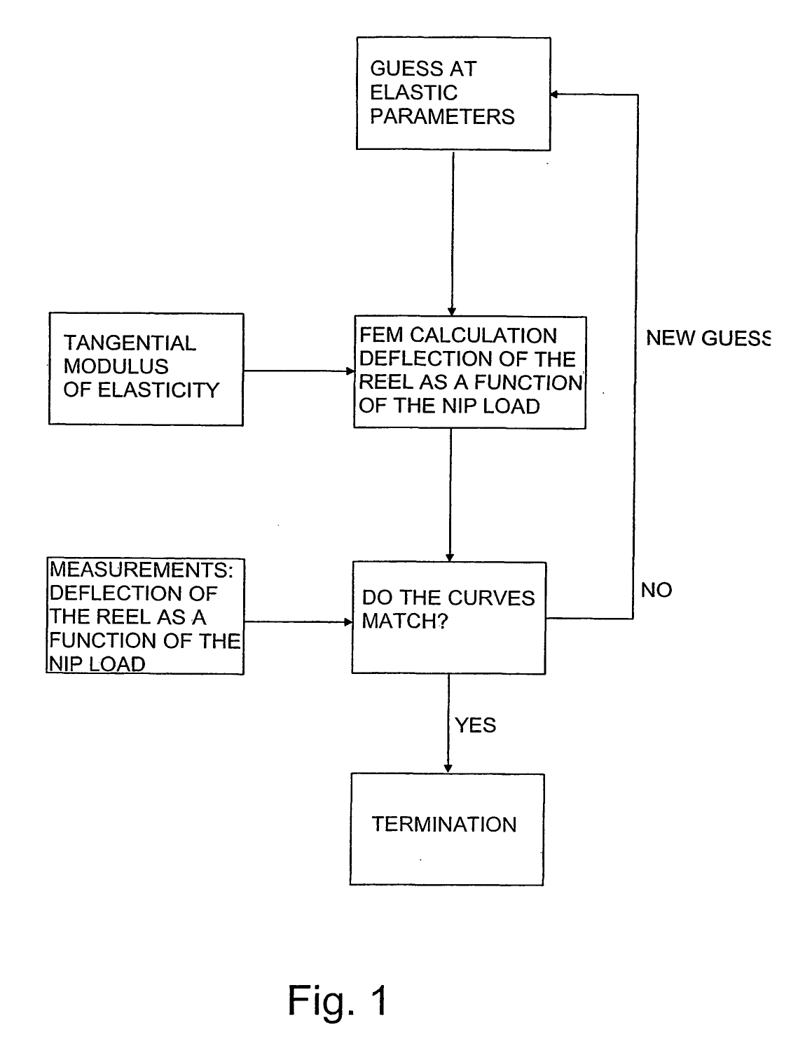

FIG. 1 shows the method according to the invention in a block chart,

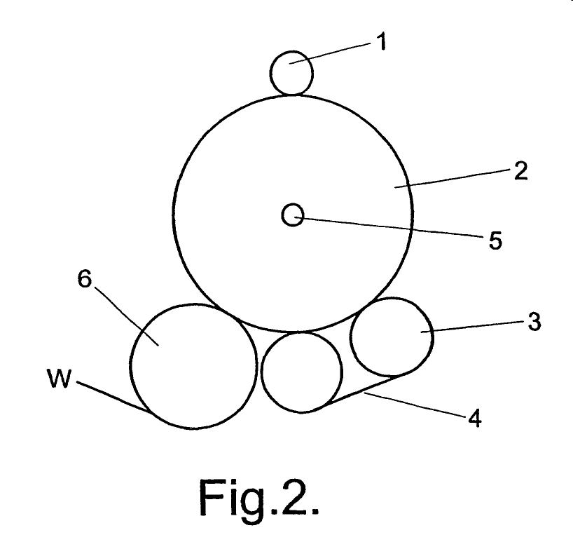

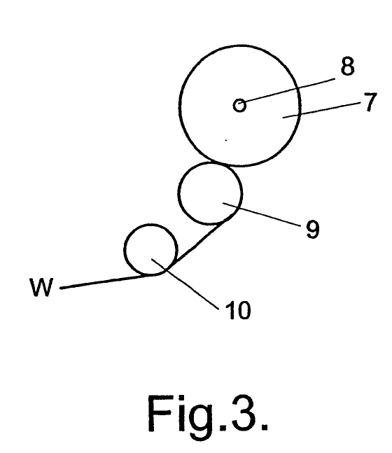

FIGS. 2 and 3 show in a principled side-view some reeling parts of the reel-up in which it is possible to apply the method according to the invention, and

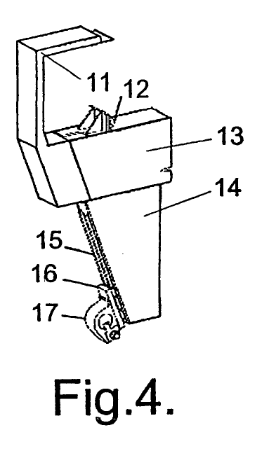

FIG. 4 shows the structure of a winding carriage of a winder in a perspective view.

FIG. 1 shows in a block chart the method according to the invention for measuring the radial modulus of elasticity of paper. To calculate the radial modulus of elasticity, an initial guess at the elastic parameters and a tangential modulus of elasticity measured from the paper are necessary.

The radial modulus of elasticity can be represented with the formula Eᵣ=Eᵣ(σᵣ), i.e. Eᵣ depends on the radial tension σᵣ. This dependency can be described with a polynomial of 1st to 3^{rd} degree. Elastic parameters which are required as initial guesses can be for example the coefficients of this polynomial.

The tangential modulus of elasticity can be measured by means of laboratory measurement, or it can be measured in a production machine. When the elastic parameters given as an initial guess are placed in the theoretical reeling model, and a curve is attained as a result of the FEM calculation on the deflection of the reel as a function of the nip load, the obtained curve is compared to the curve representing the deflection of the reel as a function of the nip load, obtained from the production machine as a measurement result. If the curves match, the initial guess is correct. If they do not match, new values are given for the elastic parameters and the comparison of the curves continues.

FIG. 2 shows a reeling part of a reel-up type in which it is possible to conduct the measurement. The reeling part shown in the drawing may be for example the reeling part of a WinBelt® reel-up. The web W is reeled on a reel 2 around a reeling core 5. The reel 2 that is being formed is supported by means of a king roll 6 and a belt loop 4 travelling around two rolls 3. The reel 2 can be loaded in during the measurement of the connection between the force and deflection for example by means of a rider roll 1.

FIG. 3 shows a winding part of a winder type in which it is possible to conduct the measurement. The winding part shown in the drawing may be for example the winding part of a WinRoll® winder. The web W enters the winding via a guiding roll 10 and a winding roll 9 and it is wound on the reel 7 around a winding core 8. The reel 7 can be loaded against the winding roll 9 during the measurement of the connection between the force and deflection for example by means of the chucks of the winding head that support the winding core 8.

FIG. 4 shows the structure of a winding carriage in a WinRoll®-winder. The winding station is formed by two winding carriages. The parts of the winding carriage are:

11 hose and cable shield

12 bearing of a transfer guide

13 upper housing

14 vertical frame

15 vertical guides of the winding carriage

16 lifting plate

17 winding head

The lifting plate 16 supporting the winding head 17 moves in the vertical direction on guides 15 located in the winding carriage. The vertical movement of the winding head 17 is measured with a position sensor placed behind the vertical guides of the winding carriage, inside the vertical frame 4. The force directed to the winding head 17 is measured with a force sensor of the winding carriage, which is placed in an opening of a cylinder of the vertical movement of the winding head 17 inside the upper housing 3.

The core around which the web is wound is attached from its ends to the winding head 17. When the paper reel is finished and the winding is stopped, the paper reel is loaded against a winding roll 9 according to FIG. 3. The force directed to the winding head 17 is thus measured with a force sensor of the winding carriage, and the deflection of the reel is obtained from a position sensor measuring the vertical movement of the winding head 17. Thus, the measurements necessary for the calculation of the radial modulus of elasticity can be conducted by using the measurement apparatus already existing in the winder.

The above-mentioned embodiments do not restrict the invention. The method according to the invention can also be applied in machine reel-ups. The main idea in this invention is that the measurements of force and deflection necessary in the calculation of the radial modulus of elasticity of paper or a corresponding material can be conducted in a production machine, and thus the laboratory measurement stage that causes extra work can be omitted.

1. A method for determining a tangential modulus of elasticity of paper or a corresponding web-like material to be reeled or wound on a reel, in which method the connection between the force and deflection of a material arranged in layers is measured, characterized in that the measurements of force and deflection necessary for calculating the radial modulus of elasticity are conducted in a production machine for paper or a corresponding material.

2. The method according to claim 1, characterized in that a reel (2, 7) reeled of paper or a corresponding material is loaded with a predetermined force in the direction of the radius of the reel, and the deflection of the reel in the direction of the radius of the reel that corresponds to the loading is registered.

3. The method according to claim 2, characterized in that a curve is obtained from the measurement results, which is the deflection of the reel as a function of the nip load.

4. The method according to claim 3, characterized in that the curve obtained from the measurement results is compared to a theoretically calculated curve of the deflection of the reel as a function of the nip load.

5. The method according to claim 4, characterized in that when the curve calculated theoretically from the deflection of the reel as a function of the nip load corresponds to the curve obtained from the measurement results, it is possible to estimate the radial modulus of elasticity.
